(19) United States
(12) Patent Application Publication
(10) Pub. No.: US 2005/0133544 A1
(43) Pub. Date: Jun. 23, 2005

(54) Functional dip tube for cosmetic dispensers

(76) Inventors: Charles Craig Tadlock, Islip Terrace, NY (US); William Bickford, Northport, NY (US)

Correspondence Address: THE ESTEE LAUDER COS, INC, 125 PINELAWN ROAD, MELVILLE, NY, 11747, US

(21) Appl. No.: 10/745,083

(22) Filed: Dec. 23, 2003

(51) Int. Cl. B67D 5/60

(52) U.S. Cl. 222/464.2; 222/189.1

(57) ABSTRACT

A dip tube for micropump dispensers which dip tube interacts with a cosmetic product. By controlling the particle distribution of one or more isolated ingredients along the length of the dip tube, the present invention achieves controlled effects. These effects may be to impart uniform chemical properties to the formulation or to create sophisticated visual effects. The invention includes a method of retrofitting an ordinary dip tube to turn it into a functional dip tube.

### FIELD OF THE INVENTION

The present invention is in the field of consumer products and packaging. More specifically, the invention is directed to a dip tube for micropump dispensers which dip tube interacts with a cosmetic product.

### BACKGROUND

Cosmetic products are sometimes packaged in consumer use containers in such a way that one or more ingredients within the container are isolated from the rest of the formulation. By “isolated”, it is meant that one or more ingredients are not freely mixed, dispersed, dissolved or suspended in the usual manner of incorporating ingredients into a cosmetic formulation. Rather, these ingredients are confined to a specific area within the consumer package and may or may not have continual physical and chemical contact with the remainder of the formulation. “Chemical contact” means that some chemical reaction, bonding or other influence has occurred between the isolated ingredients and the remainder of the formulation. For example, the influence that a magnetic field might have on a cosmetic formulation is covered by this definition of chemical contact. This type of system may be used when it is desirable to dispense product that has been acted upon by the isolated ingredient, but which does not itself contain any of the isolated ingredient. The reasons for doing this may be regulatory, mechanical or aesthetic. Certain ingredients may be legally permitted in cosmetic products as long as they do not come into contact with the consumer. Or perhaps, certain ingredients, because of their size or other characteristics are not suitable for dispensing through some of the commonly used cosmetic dispensers, for example the micropump sprayer. On the other hand, the presence of certain ingredients in the dispensed product may produce an unpleasant response in the consumer, such as a skin irritation. Examples of the types of ingredients that may be isolated from the main part of the formulation include but are not limited to: absorbents, anti-foaming agents, antifungals, antimicrobials, antioxidants, antistatics, chelating agents, corrosion inhibitors, biocides, deodorant agents, ion exchange agents, oxidizing agents, pH adjusters, preservatives, reducing agents, minerals, gem stones, magnets, metals, glass beads and biological products.

Dispensing containers which have a confinement area for one or more isolated ingredients are known. The isolated ingredient is completely retained within the confinement area, however, chemical contact is permitted to occur between the isolated ingredients and the remainder of the formulation. Examples of this include chambers that confine the isolated ingredients but which are porous to the rest of the product. These chambers may be fixedly located on the bottom of the container or may be fixed in the neck of a pour bottle (U.S. Pat. No. 5,249,712) or may be fixed in the nozzle of a squeeze bottle (U.S. Pat. No. 5,056,689; U.S. Pat. No. 5,080,800; U.S. Pat. No. 5,496,471; U.S. Pat. No. 5,612,361; U.S. Pat. No. 5,639,378) or they may be loose in the formulation. The effectiveness of this system is limited to the type of formulation involved. In order to achieve a uniform distribution of the effect of the isolated ingredient, the rest of the formulation must be able to freely move in and out of the confinement area so that chemical contact between the isolated ingredient and the rest of the formulation can take place. For this reason, non-viscous liquids are more suited for this system because thermal or kinetic agitation will increase the chances that all of the formulation will achieve chemical contact with the isolated ingredients. Use of this system with viscous products may result in incomplete chemical contact between the isolated ingredient and the rest of the formulation and non-uniform distribution of the effect of the isolated ingredient. Consider a heavy, viscous cream, for example. Portions of the heavy cream near a confinement area that contains a preservative, may be well preserved, while mold begins to appear in a portion removed from the confinement area. To counter this, one may use an isolated ingredient that is significantly more potent than would otherwise be used if the isolated ingredient was incorporated directly into the formulation. Problems here include the fact that such an isolated ingredient may not exist or the use of such potent ingredients may be legally or commercially unacceptable.

Other problems arise depending on the exact location of the chamber. If the chamber is located near the bottom of the container, then the ratio of formulation to isolated ingredients changes as product is removed from the container. This may result in an inconsistent product experience for the consumer. On the other hand, if the chamber is located near the top of the container then the formulation may not have chemical contact with the isolated ingredients, in general. Only upon shaking the container which the consumer may not do, will any chemical contact be achieved and those results may be highly variable. In the case of the chamber being located in the dispensing nozzle each portion of the formulation generally does not have chemical contact with the isolated ingredients until each portion moves through the confinement chamber on its way out of the nozzle. Drawbacks of this system include the fact that different portions of formulation have very different contact times with the isolated ingredients. Those portions which pass quickly through the dispensing system have only brief chemical contact with the isolated ingredients while a portion which, in between dispensing operations, remains in and near the nozzle confinement chamber may have a much longer contact with the isolated ingredients. Again, the result may be a non-uniform product experience for the consumer. This same problem may be encountered anytime the chamber is located anywhere in the flow path of the product, not just in a nozzle.

Dispensing containers that use a chemical or mechanical filter to isolate one or more ingredients from the remainder of the formulation just prior to being dispensed, are also known. Again, the reasons for doing so may be regulatory, mechanical or aesthetic. These systems have less of a problem with non-uniformity, but the limitations of these systems include the associated costs of the additional filter components and the fact that suitable filters which can be conveniently incorporated into the small space of cosmetic dispenser may not exist. Also, this system is only appropriate if the effect of the isolated ingredient remains even after the isolated ingredient has been removed from the formulation. This may not always be the case. Also, if the trapped ingredients clog the filter, the dispensing mechanism may become inoperable.

Mechanical pump dispensers wherein the dip tube is surrounded by an outer tube are known. U.S. Pat. No. 6,119,897 discloses an outer tube that is purely an esthetic enhancement for the dip tube. The outer tube is not porous and does not define a confinement space that is adapted or capable of confining one ore more isolated ingredients. U.S. Pat. No. 4,475,667 discloses a outer tube that is really a second dip tube that allows for inverted spraying. The outer tube is not porous and does not define a confinement space that is adapted to or capable of confining one ore more isolated ingredients. U.S. Pat. No. 4,107,043 and U.S. Pat. No. 6,227,412 disclose mechanical filters attached to the end of dip tubes, but it is only the very end of the dip tube that is surrounded by the filter housing. The filter housings does not confine any isolated ingredients and even if they did they would not achieve the results of the present invention because only a minimal portion of the dip tube is surrounded. U.S. Pat. No. 6,170,711 describes a dip tube, a portion of which is surrounded by a spherical casing that confines an isolated ingredient, i.e. a magnet. Here, however, the casing is relatively small compared to the dip tube. The reasons for this are several. Firstly, the casing must be light enough to float on the surface of the product. When the container is full, there may be insufficient space at the top of the container to fit a large casing. Also, a purpose of the small casing is to concentrate the magnetic energy inwardly over a small portion of the dip tube so as to have a significant effect on the product as it passes through that portion of the dip tube. This design is not trying to have a uniform effect over the product in the container, only the product as it passes through a small portion of the dip tube. Also, there is no disclosure of a porous outer tube.

Dip tubes with pores are known, as in U.S. Pat. No. 4,418,846 and U.S. Pat. No. 4,530,450. The porous dip tube disclosed in each patent facilitates the dispensing of a liquefied propellant phase of a three phase aerosol product. U.S. Pat. No. 6,491,463 discloses a dip tube with a plurality of apertures that allow dispensing while the container is inverted. None of these discloses an outer porous tube that defines a confinement space for one ore more isolated ingredients.

Generally, the focus of the prior art is to prevent the degradation of the appearance and performance of a very standard looking product. None of the prior art to which this invention pertains describe or suggest the ability to create sophisticated visual effects and/or improved performance of an active ingredient through the controlled distribution of one or more isolated ingredients in a consumer package.

Objects

Aims of the present invention include:
a cosmetic package that incorporates the effects of isolated ingredients uniformly throughout the product, in a manner superior to what has so far been achieved in the prior art;
a cosmetic package that uniformly incorporates the effects of isolated ingredients even in viscous products;
a cosmetic package that uniformly incorporates the effects of isolated ingredients while minimizing the potency or quantity of the isolated ingredients needed;
a cosmetic package that uniformly incorporates the effects of isolated ingredients in a self-adjusting manner so that the ratio of product to isolated ingredient can be held constant or better controlled;
a cosmetic package that uses isolated ingredients to achieve sophisticated visual effects;
a functional dip tube that supports a distribution of isolated ingredients;
a method of retrofitting an ordinary dip tube to turn it into a functional dip tube.

### SUMMARY

All of the above are achieved in a package with a cosmetic pump by taking advantage of the fact that the pump dip tube is already uniformly distributed in the package container, at least in the direction of the dip tube axis. By associating one or more isolated ingredients with the dip tube and controlling the particle distribution of the isolated ingredients along the length of the dip tube, the present invention achieves controlled effects. These effects may be to impart uniform chemical properties to the formulation or to create sophisticated visual effects.

### BRIEF DESCRIPTION OF THE DRAWINGS

FIG. 1 depicts a generic container with pump dispenser.

FIG. 2a is an elevation of the dip tube of the present invention wherein the outer tube and stop means are shown in cross section.

FIG. 2b is an enlargement and cross section of a portion of the dip tube of FIG. 2a.

FIG. 3 is an alternate embodiment of FIG. 2b showing multiple sections within the dip tube.

FIG. 4 is an alternate embodiment of FIG. 2a showing a confinement space that varies along the length of the dip tube.

FIG. 5a is an alternate embodiment of FIG. 2b showing the isolated ingredients completely bounded by the outer tube.

FIG. 5b is a cross section along line A-A of FIG. 5a.

FIG. 6 is an elevation depicting the mesh embodiment of the outer tube.

FIGS. 7a and 7b depict the collette-plug stop means useful on the embodiment of FIG. 6.

### DETAILED DESCRIPTION

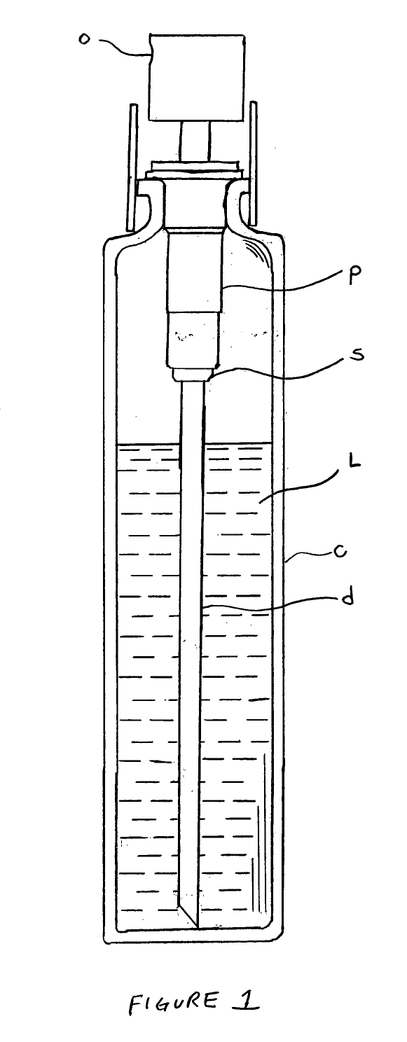

FIG. 1 depicts a generic container (c) with pump dispenser (p). The pump dispenser comprises a dip tube (d). Most commonly, dip tubes are nothing more than cylindrical tubes of plastic such as polyethylene or polypropylene. They are opened at both ends to allow the flow of product through the dip tube from the container to the pump orifice (o). The bottom of the dip tube is free while the top is attached to the stem (s) of the pump by inserting the dip tube into the stem or vice versa. In designing a package of this type the dip tube is sized in its outer diameter, its inner diameter and its length and its material is chosen for compatibility with the product (L) in which it is immersed. Typically, to maximize the amount of product that may be evacuated from the container, the length of the dip tube is sufficient to contact the bottom of the container. Sometimes dip tubes descend straight down to the bottom of the container and sometimes the dip tube may be flexed near its bottom to reach into the corner of the container. The bottom of the dip tube is sometimes notched or cut on an angle to prevent the opening on the bottom of the dip tube from being closed off when it contacts the container. Throughout this specification the phrase “dip tube proper” refers to a conventional dip tube just described or the conduit that permits fluid communication from the container to the pump orifice. The present invention further provides the dip tube proper with a confinement space for isolated ingredients such that the isolated ingredients can be distributed in a controlled way over a substantial portion of the height of the dip tube proper. The phrase “substantial portion of the height” means at least 50% of the height. More preferably, the isolated ingredients are distributed over at least 75% of the height and most preferably, this is at least 90% of the height. At a distribution of 50% of the height, significant effects are already achieved, the benefits of which increase as even more of the height of the dip tube proper is utilized.

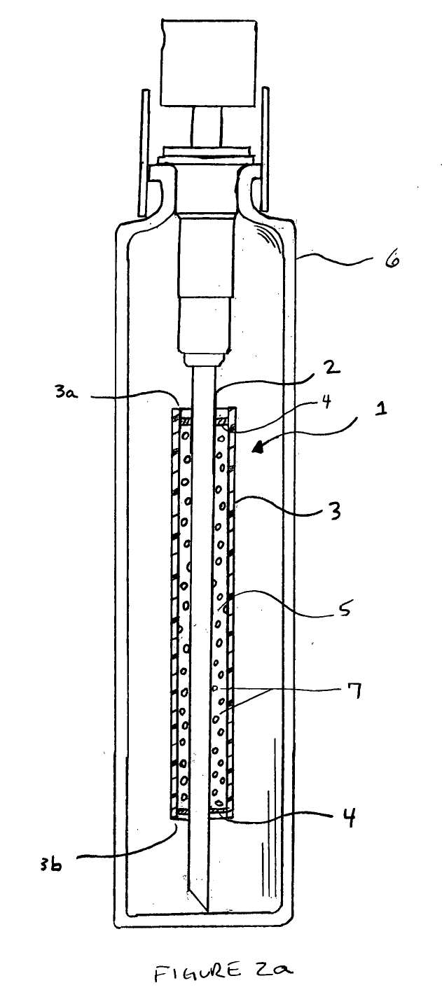

A first embodiment of the functional dip tube according to the present invention is shown in FIG. 2a. The functional dip tube 1 comprises a dip tube proper 2, and an outer tube 3 (shown in cross section), which circumferentially surrounds the dip tube proper over at least a portion of the height of the dip tube proper. As shown, the outer tube surrounds the dip tube proper substantially over the whole length of the dip tube proper. The top 3a and bottom 3b of the outer tube attach to the dip tube proper by any suitable means 4. Suitable means include a friction fit gasket, a snap-fit collar system as described below, integral molding, gluing or fusing the top and bottom of the outer tube to the dip tube proper. A confinement space 5 exists between the outer tube and the dip tube proper. This space is adapted to contain and confine one or more isolated ingredients (I, not shown in FIG. 2a for clarity). Pores 7 are provided along to the length of the outer tube allowing fluid communication between the space 5 and the outside of the outer tube. The top and bottom of the outer tube may also have pores. The pores are sized to prevent the isolated ingredient from exiting the confinement space while allowing at least a portion of the rest of the formulation to enter and exit the confinement space. The density or overall number of pores may be determined by routine experimentation by observing the level of affect achieved by the isolated ingredient and adjusting the number of pores appropriately.

When attached to a container (6), the outside of the outer tube is the inside of the container that holds the formulation (not shown in FIG. 2a for clarity). The dip tube proper and outer tube may be made of the same or different materials. For a given length of the outer tube, the volume of the confinement space is controlled by managing the distance D between the outer wall 2c of the dip tube proper and the inner wall 3c of the outer tube (see FIG. 2b). This volume is chosen to accommodate the specific amount of isolated ingredient used in the formulation. A further consideration is that the overall diameter of the functional dip tube must be such that it can fit into the container on which it will be used. Typical cosmetic and personal care containers have neck openings in the range of 8 to 105 millimeters. The overall diameter of the functional dip tube may be smaller than the container orifice diameter or it may be larger as long as the functional dip tube is such that it can be squeezed through container orifice. In a simple embodiment, the confinement space extends substantially for the length of the dip tube proper and is filled with one isolated ingredient. In this manner, the isolated ingredient has fluid communication with the rest of formulation along the height of the container. The distribution of isolated ingredient is substantially constant along the height of the product in the container. For a container with a fairly constant cross section along its height, a cylindrical bottle for example, the effect of the isolated ingredient is evenly distributed along the height of the product in the bottle. Furthermore, as product is dispensed from the container, the ratio of product to isolated ingredient that is in chemical contact with the formulation remains relatively constant, so that the consumer experience is far more consistent than has previously been achieved. Even for containers with more exotic shapes, the effect of the isolated ingredients is distributed along the height of the container rather than localized as in the prior art. However, in more sophisticated embodiments of the present invention, exotic container shapes can be compensated for, unlike anything in the prior art.

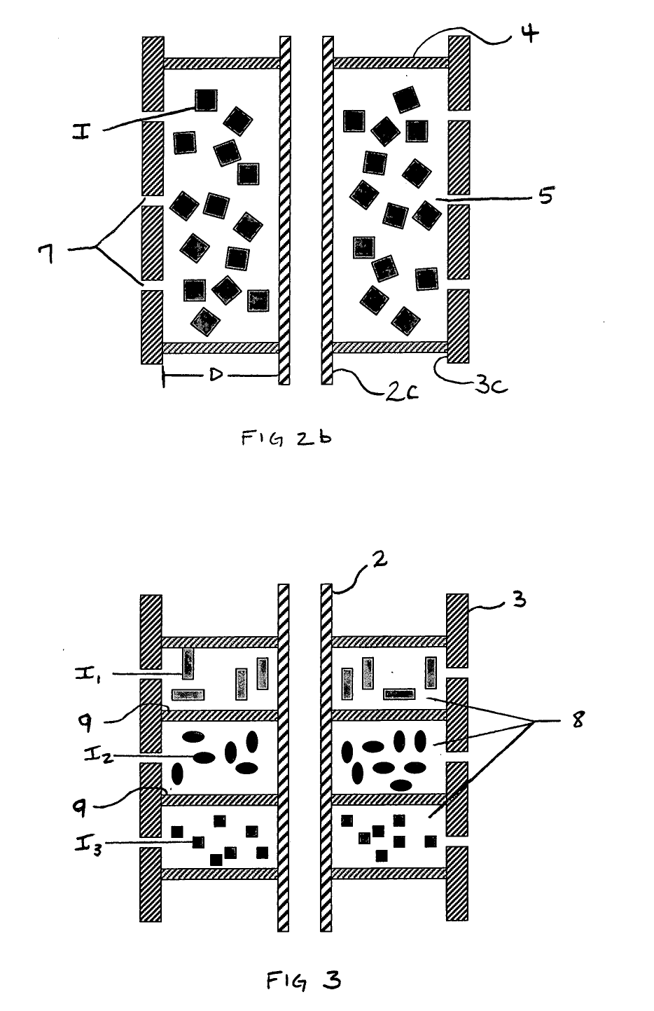

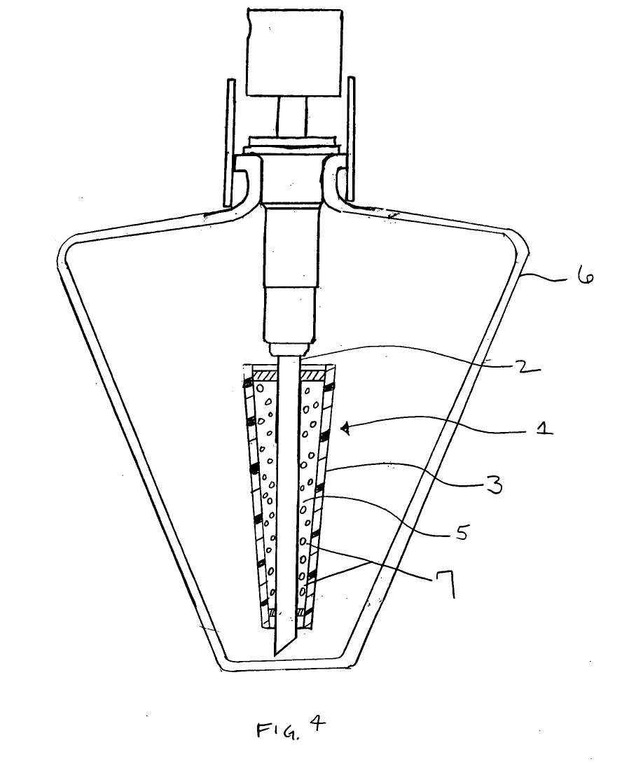

The outer tube 3 may be substantially the same length as the dip tube proper 2 or the outer tube may be shorter than the dip tube proper. In the preferred embodiment, the dip tube proper extends downward, beyond the bottom (3b) of the outer tube, however, the bottom of the outer tube may be substantially at the same depth as the lower end of the dip tube proper. The confinement space 5 may be continuous or it may be partitioned into sections 8 forming any number of patterns along the length of the dip tube (see FIG. 3). These sections may abut each other or be separated by a gap. Each section may contain one or more isolated ingredients (I₁, I₂, I₃). The sections are formed by partition walls 9 located between the dip tube proper and the outer tube. The distance D between the dip tube proper and the outer tube may be constant or it may vary along the length of the dip tube proper (see FIG. 4). The ability to control the volume of confinement space along the length of the dip tube proper allows the formulator to position varying amounts of isolated ingredient along the height of the product in the container. In this way, even if the container has an exotic, irregular shape, routine experimentation will yield the proper distribution of isolated ingredients that achieves satisfactory results. For example, wider portions of the container may be provided with more isolated ingredient than narrower portions, the difference in the amount of isolated ingredient in each portion depending on the relative dimensions of the wider and narrower portions. By using a substantial length of the dip tube proper to support a controlled distribution of one or more isolated ingredients, the present invention surpasses the prior art in ability to affect the remainder of the formulation in the consumer use package.

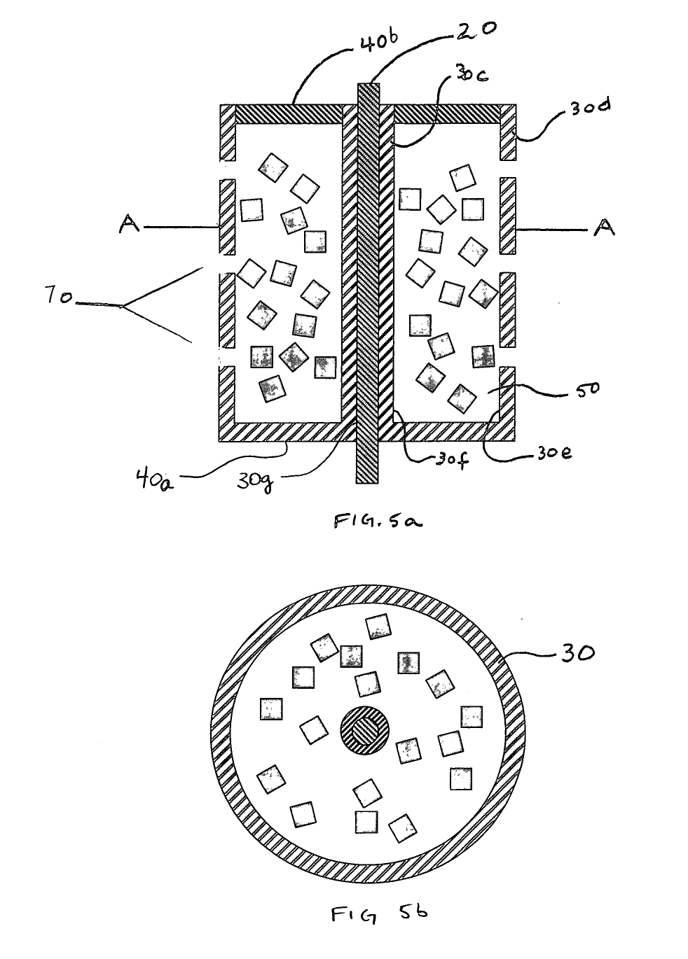

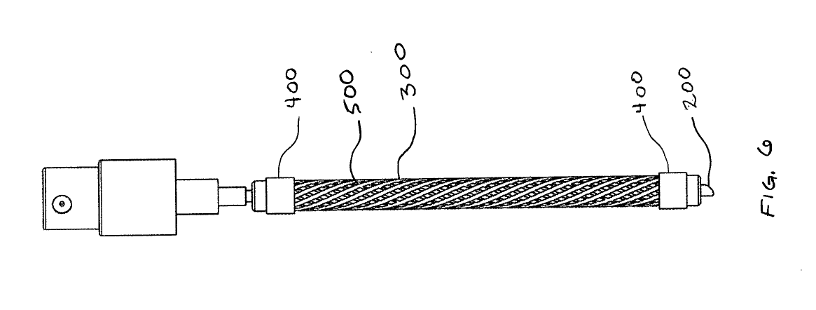

In one variation of the present invention (see FIGS. 5a, 5b), the outer tube 30 comprises coaxial inner and outer walls 30c, 30d. The inner and outer walls each have inner and outer surfaces. A confinement space 50 is located between the inner surface (30e) of the outer wall and the outer surface 30f of the inner wall. The ends of the confinement space are closed off by any suitable means, but shown in FIG. 5a as an integrally molded end-piece 40a on the bottom and a gasket 40b on the top. Pores 70 pass through the outer wall of the outer tube creating fluid communication between the space outside the outer tube and the confinement space. The end-piece and gasket may also have pores. The inner surface 30g of the inner wall of the outer tube has a radius R such that the outer tube may receive the dip tube proper 20 into itself. If radius R is sized appropriately, the outer tube may be held in place on the dip tube proper by friction. Otherwise some other means of attachment may be used, such as adhesive or integral molding.

In another variation of the present invention, the wall of the outer tube may be impregnated with the isolate ingredient. In this embodiment pores need not be provided if the natural porosity of the outer tube is sufficient to allow fluid communication between the isolated ingredient and the rest of the formulation. The isolated ingredient may be impregnated into the outer tube simply by incorporating the isolated material into the plastic slurry prior to molding or extruding the outer tube.

In still another variation of this, the isolated material is impregnated in the outer tube, but no fluid communication occurs between the isolated material and the rest of the formulation. In this case, the isolated material can exert its influence through the outer tube. An example of this would be when the isolated ingredient is magnetic. An outwardly directed magnetic field would arise within the formulation even without said fluid communication. Carrying this one step further, the outer tube may be eliminated and the isolated material can be impregnated into the dip tube proper.

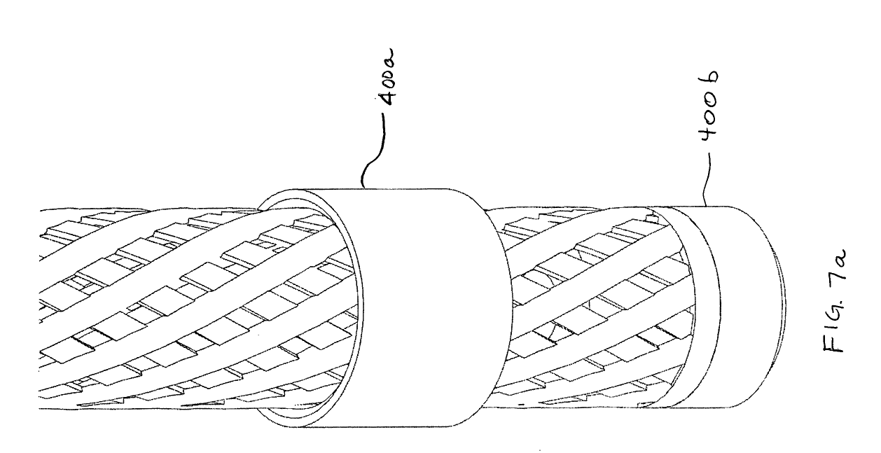

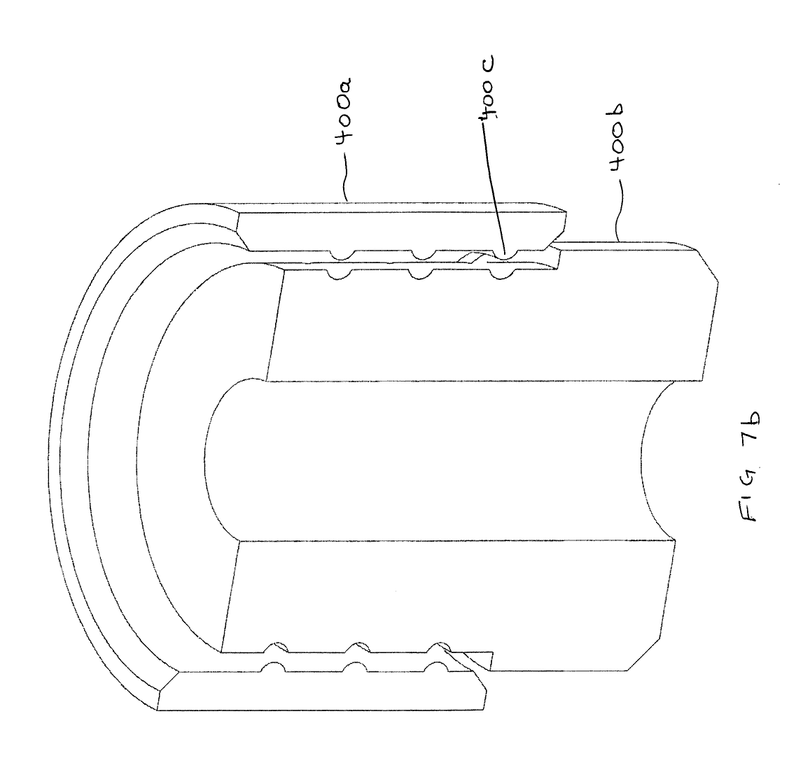

In another variation of the present invention the outer tube is formed of a mesh 300 (see FIG. 6). A confinement space 500 is bounded by the mesh and the dip tube proper 200. The confinement space may again be partitioned and each section may be made to any suitable volume for holding an appropriate amount of isolated ingredient. The mesh is such that the product in the container has fluid contact with the isolated ingredients, but the isolated ingredients are dimensioned such that they are unable to pass through the mesh. The mesh may be a woven textile fabric or a plastic or metal screen. Also depicted in FIGS. 6 and 7 is an embodiment of the stop means 400. This snap-fit collar comprises an annular collette 400a and a plug 400b that snap fits into the collette. The collette is slipped over the mesh and then the plug is inserted into the top or bottom of the mesh. The collette is then slid up or down over the plug, squeezing the mesh in between the collette and plug. The collette and plug may be provided with cooperating fitments or detents 400c to secure the plug inside the collette.

Functional dip tubes according to the present invention may be manufactured and assembled using well known molding, extruding and assembling technology. However, the present invention is further directed to a method of retrofitting ordinary non-functional dip tubes to produce functional dip tubes according to the present invention. The method comprises the step of positioning a confinement space that is adapted to contain within itself, one or more isolated ingredients, around a dip tube proper, over a substantial portion of the height of the dip tube proper.

It should be understood that the invention as thus described may be practiced in ways that are equivalent to the invention as circumscribed by the appended claims. A person of ordinary skill in the art will readily comprehend such insubstantial variations and these are also covered by the claims.

1. A functional dip tube for a pump dispenser comprising:
a dip tube proper;
one or more confinement spaces surrounding a substantial portion of the height of the dip tube proper; and
one or more isolated ingredients located within the confinement space.

2. A functional dip tube according to claim 1 further comprising an outer tube that surrounds a substantial portion of the height of the dip tube proper, the outer tube comprising top and bottom ends that attach to the dip tube proper.

3. The functional dip tube according to claim 2 wherein the outer tube further comprises pores that permit fluid communication between the confinement space and the exterior of the outer tube.

4. The functional dip tube according to claim 3 wherein the pores are sized to prevent the isolated ingredient from exiting the confinement space.

5. The functional dip tube according to claim 1 comprising more than one confinement space.

6. The functional dip tube according to claim 5 wherein each confinement space contains one or more isolated ingredients.

7. The functional dip tube according to claim 2 wherein the dip tube proper and the outer tube are separated by a distance that varies along the length of the dip tube proper.

8. The functional dip tube according to claim 2 wherein the outer tube is formed of a mesh.

9. The functional dip tube of claim 8 wherein the mesh is selected from the group consisting of a woven textile, a plastic screen and a metal screen.

10. The functional dip tube according to claim 1 wherein at least one of the isolated ingredients is magnetic.

11. The functional dip tube according to claim 1 wherein at least 50% of the height of the dip tube proper is surrounded by the one or more confinement spaces.

12. The functional dip tube according to claim 11 wherein at least 75% of the height of the dip tube proper is surrounded by the one or more confinement spaces.

13. The functional dip tube according to claim 12 wherein at least 90% of the height of the dip tube proper is surrounded by the one or more confinement spaces.

14. The functional dip tube according to claim 1 further comprising an outer tube that surrounds at least a portion of the dip tube proper, the outer tube comprising:
top and bottom ends; and
coaxial inner and outer walls, such that the one or more confinement spaces are located between the inner and outer walls.

15. A functional dip tube for a pump dispenser comprising:
a dip tube proper; and
one or more confinement spaces surrounding a substantial portion of the height of the dip tube proper, wherein the one or more confinement spaces are adapted to or are capable of confining one or more isolated ingredients located within the confinement space.

16. A dispensing package comprising:
a container having a neck finish suitable for receiving a pump dispenser;
a chemical preparation disposed in the container;
a pump dispenser attached to the container, the pump dispenser comprising a functional dip tube having:
a dip tube proper;
a confinement space surrounding at least a portion of the dip tube proper; and
one or more isolated ingredients located within the confinement space.

17. A method of making a functional dip tube comprising the step of positioning a confinement space that is adapted to contain within itself one or more isolated ingredients, around a dip tube proper, over a substantial portion of the height of the dip tube proper.
